(19) United States
(12) Patent Application Publication
(10) Pub. No.: US 2024/0116780 A1
(43) Pub. Date: Apr. 11, 2024

(54) DYE RECOVERY PRODUCTS AND PROCESSES

(71) Applicant: LON NEGRIN, BOCA RATON, FL (US)

(72) Inventor: LON NEGRIN, BOCA RATON, FL (US)

(21) Appl. No.: 18/213,134

(22) Filed: Jun. 22, 2023

Related U.S. Application Data
(60) Provisional application No. 63/355,079, filed on Jun. 23, 2022.

(51) Int. Cl. C02F 1/42; B01J 20/24; B01J 20/28; C02F 1/00; C02F 1/44; D06P 1/00; D06P 1/66; D06P 7/00

(52) U.S. Cl. CPC C02F 1/42; B01J 20/24; B01J 20/28023; B01J 20/28038; C02F 1/008; C02F 1/441; D06P 1/0008; D06P 1/66; D06P 7/00; C02F 2001/422; C02F 2101/308

(57) ABSTRACT

A filter for capturing dyestuff is provided. The filter includes a housing defining an inlet. The housing further includes an outlet spaced from the inlet. The housing further includes a cartridge in fluid communication with the inlet and the outlet. The inlet is adapted to receive effluent including dyestuff and the outlet is adapted to release the effluent. The filter further includes a substrate disposed within the cartridge. The substrate includes an active material. The active material has an affinity for the dyestuff. The dyestuff is present in the effluent at the inlet in a first amount and not present in the effluent at the outlet or present in a second amount with the second amount less than the first amount. The filter is composed of a textile composition made fiber or fabric which can be recycled by mulching back into a dyed fiber upcycling the normally wasted dyestuff, to now be reused in an upcycled dyed textile production. The filter with its reusable cartridge, the substrate which bonds and upcycles waste dyestuff operates in a linear or preferable circular economy.

This application claims priority to and the benefit of U.S. application Ser. No. 63/355,079, filed Jun. 23, 2022, which application and all accompanying documents filed therewith including, but not limited to, any appendices and/or exhibits, are incorporated by reference in their entireties for all purposes.

### FIELD OF THE INVENTION

The field of the invention is filters, systems, and methods for capturing dyestuffs, especially as it relates to cationically charged fibers for capturing anionic dyestuffs.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

It is well known that conventional dyeing in industries such as textiles, leather, papermaking, plastics, and cosmetics leads to the discharge of large amounts of salt and dyestuff to the environment. Chemically, these dyestuffs can be classified as either anionic or cationic based on their chemical structure. In aqueous solution, anionic dyestuffs are negatively charged due to the presence of sulphonate (SO³⁻) groups, while cationic dyes are positively charged due to the presence of protonated amine or sulfur containing groups. Industrial effluents which are mostly in the form of wastewater contaminated with dyestuff pose unprecedented environmental threat especially when they are discharged into the hydrosphere.

For example, dyestuffs designed to be applied to fibers are typically water soluble and have anionic substituents. During rinsing of the dyed fibers, dye molecules not fixed to the fibers are carried away with the rinse water resulting in highly colored wastewater being discharged to the environment. Many of dyestuffs are toxic and potentially carcinogenic. Therefore, it is a health priority to eliminate dyes from raw industrial wastewater.

Many approaches have been adopted in an effort to remove dyestuffs from industrial wastes. Some of the common approaches can be categorized as: chemical, physical, and biological methods. Chemical and biological methods are usually energy intensive, not completely effective, and often generate large amounts of by-products during the removal process. Physical methods, on the other hand, are considered simple and mainly because they do not produce several byproducts, but are not completely effective and create a toxic solid waste that must also be collected, removed, and disposed. Physical methods include flocculation, precipitation, membrane filtration and adsorption. Adsorption of cationic and anionic dyestuffs on natural or synthetic adsorbents such as activated carbons, zeolites, chitosan beads, polymer resins, cellulosic resins, and modified cross-linked starch, has been considerably investigated. The efficacy of these adsorbents, however, varies from one material to another.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, even though various systems and methods of cellulosic fiber dying are known in the art, all or almost all of them suffer from several drawbacks. Therefore, there remains a need for compositions and methods for improved dying processes with reduced emissions.

### SUMMARY OF THE INVENTION

The inventive subject matter is directed to various filters, systems, and methods for capturing dyestuff from effluent.

In certain embodiments, a filter for capturing dyestuff is provided. The filter comprises a housing defining an inlet. The housing further comprises an outlet spaced from the inlet. The housing further comprises a cavity in fluid communication with the inlet and the outlet. The inlet is adapted to receive effluent comprising dyestuff and the outlet is adapted to release the effluent. The filter further comprises a substrate disposed within the cavity. The substrate comprises an active material. The active material has an affinity for the dyestuff. The dyestuff is present in the effluent at the inlet in a first amount and is not present in the effluent at the outlet or in a second amount with the second amount less than the first amount.

In various embodiments, a method of capturing dyestuff is also provided. The method comprises providing the filter. The method further comprises exposing effluent comprising dyestuff in the first amount to the filter to form effluent comprising no dyestuff in the second amount or with second amount is less than the first amount.

In other embodiments, a method of sequestering dyestuff to form a cured dyestuff is also provided. The method comprises providing the filter comprising the substrate. The method further comprises exposing effluent comprising dyestuff in the first amount to the filter to form effluent comprising no dyestuff in the second amount or with second amount is less than the first amount.

The method further comprises combining a cartridge to hold the substrate in a reusable manor and the substrate to form the cured dyestuff.

In yet other embodiments, a method of recycling dyestuff to form a recycled material is also provided. The method comprises providing the filter comprising the substrate. The method further comprises exposing effluent comprising dyestuff in the first amount to the filter to form effluent comprising no dyestuff in the second amount or with second amount is less than the first amount. The method further comprises combining a reusable cartridge and the substrate to form the cured dyestuff. The method further comprises manipulating the cured dyestuff on the substrate to form the recycled dyed material from the cured dyestuff on the substrate.

In still other embodiments, a filtering system for capturing dyestuff is also provided. The filtering system comprises a discharge stream of effluent containing dyestuff having a first discharge outlet and a second discharge outlet adapted to provide effluent comprising the dyestuff. The filtering system further comprises a first filter in fluid communication with the first discharge outlet and adapted to capture all if not at least a portion of the dyestuff. The filtering system further comprises a second filter in fluid communication with the second discharge outlet and adapted to capture all if not at least a portion of the dyestuff. The filtering system further comprises a sensor assembly in fluid communication with the first filter and the second filter and adapted to detect an amount of the dyestuff. The system is adapted to direct effluent to the second filter when the sensor detects a predetermined amount of dyestuff being released from the first filter.

In some aspects of the invention, cationized cellulosic fibers or fabrics are placed in a cartridge through which the discharge stream passes. The cationically charged fibers or fabrics may attract any anionic material and remove them from the discharge stream. The color of the discharge stream can be monitored, and the discharge stream diverted to another cationized filter cartridge when the color reaches a prescribed level. This filter system may be attached directly to the dyeing vessel, a washing vessel, a reverse osmosis filtration unit or a holding tank containing the effluent containing dyestuff, so the dyestuff will be caught and filtered out of the effluent prior to entering the water treatment plant. This filter system may be designed with a dual filter passageway, so when one filtering stream has reached capacity detected by a colorimeter observing the effluent after the filters outlet, it can automatically switch to the other filter passageway which contains a fresh clean filter. There may also a bypass passageway on the exit of the dye vessel or the entrance leading to the filter system, for effluent baths of the dyeing vessel which do not contain dyestuff due to other functions which are performed like bleaching, neutralization, or bio-polish of the fabric to move to the wastewater treatment plant to be treated and thoroughly restored using other appropriate methods.

In some aspects of the invention, cationized cellulosic fibers or fabrics are placed in a cartridge through which the discharge stream passes. The cationically charged fibers or fabrics may attract any anionic material and remove them from the discharge stream. The color of the discharge stream can be monitored, and the discharge stream diverted to another cationized filter cartridge when the color reaches a prescribed level. In the case where the filter system may be attached directly to a holding tank, the dyeing vessel will be attached to a reverse osmosis system first to filter out any loose fibers or salt created during the neutralization step in the dye rinse off step of some dyeing procedures. The cleaned dyestuff effluent only containing the dyestuff will then enter the dyestuff filtration system to remove the dyestuff without foreign particle so the recycling of the substrate fill has no contamination.

In various embodiments, the filtering system is designed for cationic dyeing systems or other dyeing systems which utilize salt free dyeing and have a very high fixation rate of the dyestuff in the dye process. With no dyestuff leaving the dye filter or entering the water treatment plant, the prevention of dye infested water treatment plant sludge may be achieved. In addition, the risk of dyestuff escaping the water treatment plant is eliminated thereby mitigating risks to the ecosystem relating to degradation of the dyestuffs into carcinogenic and mutagenic chemicals.

Various objects, features, aspects, and advantages of the inventive subject matter will become more apparent from the following detailed description of preferred embodiments.

### BRIEF DESCRIPTION OF THE DRAWING

FIG. 1 is a schematic illustrating a non-limiting embodiment of a filtering system for capturing dyestuff.

### DETAILED DESCRIPTION

The inventor has unexpectedly discovered that filters comprising cationically charged fibers or fabrics may attract anionic materials, such as anionic dyestuffs, and separate them from the effluent discharge stream. Dyestuff molecules dissolved in the effluent have a very difficult time being captured as they are not particles. It is the highly charged cationically charged fibers and fabrics which ionically bond to the dye to form a cured dyestuff. Advantageously, the dyestuff which is washed off a fabric which was intended to be covalently bonded to the original fabric, had become hydrolyzed during the dyeing process thus losing its ability to covalently bond with the fabric, and now in the effluent of the dyeing vessels effluent can only be bonded with a strong ionic bond, that uses different method of bonding which uses the forces of opposite charges attracting each other. As the effluent with the dissolved ionic dyestuff passes through the dyestuff filters cartridge filled with the highly charged cationic fibers or fabric the dyestuff can now create a new permanent bond to the cartridges fill. The cartridge is made to be opened, releasing the dyed fill and the cartridge structure can be reused again. The fill once dried can also be reused by being manipulated to form a variety of recycled dyed materials, such as fibers, yarns, fabric, and rope, while minimizing the risk of the dyestuffs being released to the environment. The cartridge and the fill of this first of its kind ionic dyestuff filter is designed for all components and what it is filtering to be reused, moving from a linear model of use and discard to a circular model of use and reused. The filter is also built with a stainless-steel vessel which will last for many years to come. However, it is to be appreciated that the filter may be designed to attract other material, such as cationic dyestuffs, by utilizing other charged fibers, such as anionically charged fibers.

The cationically charged fibers or fabrics may be formed from recycled fabric, rope, or yarn and then disposed in the filters cartridge. However, it is to be appreciated that the cationically charged fibers may be formed from non-recycled knitted, woven, or nonwoven fabrics, wasted undyed greige fabric, or cutting table undyed scrap garment dye fabric. As effluent comprising the dyestuff moves through the filter, the filters cartridges fill may become fully absorbed with the dyestuff. The filter may be replaced with another filter or the cationically charged fibers may be replaced within the same filter cartridge.

In an exemplary embodiment, a system comprises ten filters, in parallel, in fluid communication with the effluent discharge stream may be utilized. The system may comprise a color sensor for detecting whether dyestuff moves through the filter without getting captured. When this occurs, the system will direct the effluent to another filter in the system from the used filter. The used filters a cartridge or series of cartridges may then be unscrewed releasing the ionic bonded dyes to the strongly cationized fill and then left to air dry to cure the dyestuff permanently. The cured dyestuff may then be mulched to form recycled fibers. From there the recycled fibers may be spun into yarn or rope that is already dyed.

The dyestuff may comprise azo dyes containing reactive groups that have been hydrolyzed. Reactive dyes are compounds that contain one or more reactive groups, which form covalent links with oxygen, nitrogen, or sulfur atoms from cellulose fibers (hydroxyl group), protein fibers (amino, hydroxyl and mercaptan groups) and polyamides (amino group), providing greater stability to the fabric color. However, it is to be appreciated that hydrolyzed dyestuffs depend on the ionic attraction to be upcycled by the filters oppositely charged fill.

The filter may be utilized with a variety of dyeing processes and with various equipment, such as at the drain of a dye jet, a continuous washing ranges, or a digital printer. In various embodiments, the dyeing process is substantially salt free. The dyeing process typically generates effluent comprising dyestuff that has hydrolyzed and failed to bind during the process. The effluent is typically processed at a water treatment plant or dumped in the environment which is toxic to our water and ecosystem. Dyestuff release into the ecosystem can have a half-life of over 45 years.

In certain embodiments, the filter comprises a housing/vessel defining an inlet. The housing further comprises an outlet spaced from the inlet. The housing further comprises a cartridge or series of cartridges in fluid communication with the inlet and the outlet. The inlet is adapted to receive effluent comprising dyestuff and the outlet is adapted to release the effluent. The dyestuff is present in the effluent at the inlet in a first amount and not present or present in the effluent at the outlet in a second amount with the second amount less than the first amount. The second amount of dyestuff may be at least 1.5, 2, 2.5, 3, 3.5, 4, 4.5, 5, 10, 15, 20, 25, 30, 35, 40, 45, 50, 60, 70, 80, 90, 100, 200, 300, 400, 500, 1,000, or 10,000 times less than the first amount of dyestuff. The effluent has a first color strength at the inlet and a second color strength at the outlet with the second color strength is lower than the first color strength. The second color strength of the effluent may be at least 1.5, 2, 2.5, 3, 3.5, 4, 4.5, 5, 10, 15, 20, 25, 30, 35, 40, 45, 50, 60, 70, 80, 90, 100, 200, 300, 400, 500, 1,000, or 10,000 times less than the first color strength of the effluent.

The filter further comprises a substrate disposed within the cartridge or series of cartridges. The substrate comprises cellulosic fibers, cellulosic blend fibers, fabrics, or a combination thereof. The cellulosic fiber or fabrics comprises cotton, viscose, wood pulp, hemp, bamboo, etc. the substrate further comprises an active material, the active material has an affinity for the dyestuff. The active material comprises a cationic material. The cationic material comprises a quaternary ammonium compound. The quaternary ammonium compound is 3-chloro-2-hydroxypropyltrimethylammonium chloride (CHPTAC) but other bi-quaternary amines or other cationic chemistry will be used to make the cationic charged fibers and/or fabrics used as the substrate.

In various embodiments, a method of capturing dyestuff is also provided. The method comprises providing the filter. The method further comprises exposing effluent comprising dyestuff in the first amount to the filter to form effluent comprising dyestuff in the second amount. The second amount is less than the first amount. The second amount of dyestuff may be at least 1.5, 2, 2.5, 3, 3.5, 4, 4.5, 5, 10, 15, 20, 25, 30, 35, 40, 45, 50, 60, 70, 80, 90, 100, 200, 300, 400, 500, 1,000, or 10,000 times less than the first amount of dyestuff.

In other embodiments, a method of sequestering dyestuff to form a cured dyestuff is also provided. The method may comprise providing the filter comprising the substrate. The method may further comprise exposing effluent comprising dyestuff in the first amount to the filter to form effluent comprising dyestuff in the second amount. The second amount of dyestuff may be at least 1.5, 2, 2.5, 3, 3.5, 4, 4.5, 5, 10, 15, 20, 25, 30, 35, 40, 45, 50, 60, 70, 80, 90, 100, 200, 300, 400, 500, 1,000, or 10,000 times less than the first amount of dyestuff. The method may further comprise unscrewing the filter cartridge releasing the ionically bonded dyestuff and letting it air dry to form the cured dyestuff on the substrate fibers either in fiber or fabric form.

In some embodiments, a method of recycling dyestuff to form a recycled material is also provided. The method comprises providing the filter comprising the substrate. The method further comprises exposing effluent comprising dyestuff in the first amount to the filter to form effluent comprising dyestuff in the second amount. The second amount of dyestuff may be at least 1.5, 2, 2.5, 3, 3.5, 4, 4.5, 5, 10, 15, 20, 25, 30, 35, 40, 45, 50, 60, 70, 80, 90, 100, 200, 300, 400, 500, 1,000, or 10,000 times less than the first amount of dyestuff. The method may further comprise unscrewing the filter cartridge releasing the ionically bonded dyestuff and letting it air dry to form the cured dyestuff on the substrate fibers either in fiber or fabric form.

The method further comprises manipulating the cured dyestuff to form the recycled material. The step of manipulating the cured dyestuff on the substrate comprises mulching the cured dyed substrate to form recycled fibers and spinning the recycled fibers to form recycled fibered material. However, it is to be appreciated that any process may be utilized to manipulate the cured dyed substrate to form the recycled fibers or recycled fibered material. The recycled fibered material comprises a rope, a yarn, or a combination thereof. However, it is to be appreciated that any fibered material may be formed from the recycled fibers.

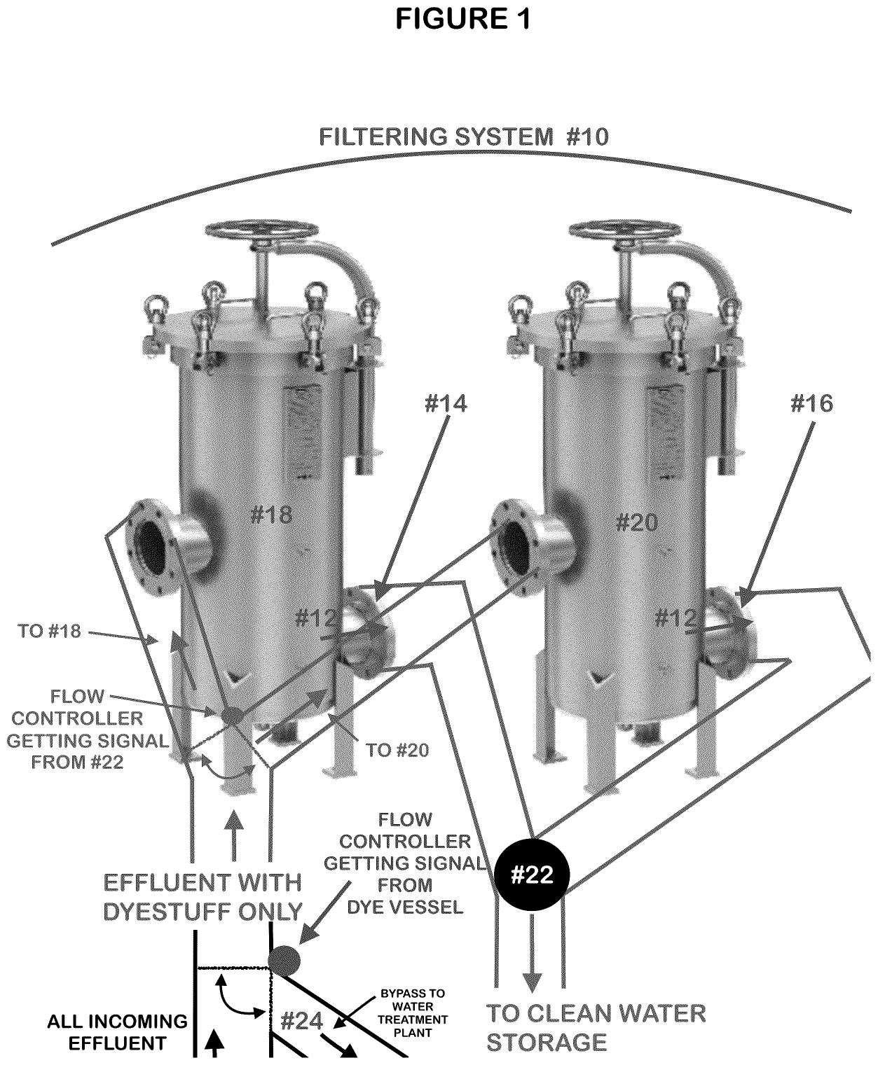

With reference to FIG. 1, in certain embodiments, a filtering system 10 for capturing dyestuff is also provided. The filtering system 10 comprises a discharge stream 12 having a first discharge outlet 14 and a second discharge outlet 16 adapted to provide effluent comprising the dyestuff. The filtering system 10 further comprises a first filter 18 in fluid communication with the first discharge outlet 14 and adapted to capture at least a portion of the dyestuff. The filtering system 10 further comprises a second filter 20 in fluid communication with the second discharge outlet 16 and adapted to capture at least a portion of the dyestuff. The filtering system 10 further comprises a sensor assembly 22 in fluid communication with the first filter 18 and the second filter 20 and adapted to detect an amount of the dyestuff.

The system 10 is adapted to direct effluent to the second filter 20 when the sensor assembly 22 detects a predetermined amount of dyestuff being released from the first filter 18. The system 10 is adapted to direct effluent to the first filter 18 when the sensor assembly 22 detects a predetermined amount of dyestuff being released from the second filter 20. In various embodiments, the sensor assembly 22 comprises a colorimetric sensor adapted to detect color strength of effluent. However, it is to be appreciated that any sensor may be utilized so long as it can directly or indirectly detect an amount of dyestuff. The discharge stream 12 may further comprise a third discharge outlet 24 that is adapted to bypass the first filter 18 and the second filter 20 and is in fluid communication with the environment.

The filtering system can be designed to be completely circular reusing all its parts, components, cartridges, substrate and upcycle normally discarded waste dyestuff. The cartridge from the filter can be preferably reusable by having the ability to unscrew, separate, empty the used substrate with the dyestuff bonded to air dry to permanently bond, and then the cartridge can be easily repacked with fresh charged substrate to be used again preferably following a circular model and not a linear model. The filtering system can contain a cartridge or series of cartridges which can be preferably reusable, contains a substrate with an ionic charge which can attract and filter anionic hydrolyzed dyestuff which is not a particle nor has the ability of forming a covalent bond.

Further examples, considerations, and contemplations are included in Appendix A, which forms express part of this disclosure.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. Where the specification and claims refer to at least one of something selected from the group consisting of A, B, C . . . and N, the text should be interpreted as requiring only one element from the group, not A plus N, or B plus N, etc.

What is claimed is:

1. A filter for capturing dyestuff, comprising:
a housing defining an inlet, an outlet spaced from the inlet and a cartridge or series of cartridges in fluid communication with the inlet and the outlet, the inlet adapted to receive effluent comprising dyestuff, and the outlet adapted to release the effluent; and
a substrate disposed within the cartridge and comprising an active material, the active material having an ionic affinity for the dyestuff;
wherein the dyestuff is present in the effluent at the inlet in a first amount and not present in the effluent at the outlet or present in a second amount with the second amount less than the first amount.

2. The filter of claim 1, wherein the active material comprises a cationic material.

3. The filter of claim 2, wherein the cationic material comprises a quaternary ammonium compound, a bis-quaternary ammonium compound or any other cationic compound.

4. The filter of claim 3, wherein the quaternary ammonium compound is 3-chloro-2-hydroxypropyltrimethylammonium chloride (CHPTAC).

5. The filter of claim 1, wherein the substrate comprises cellulosic fibers, cellulosic blend fibers, fabrics, or a combination thereof.

6. The filter of claim 5, wherein the cellulosic fiber comprises cotton, viscose, wood pulp, hemp, bamboo, etc.

7. The filter of claim 1, wherein the effluent has a first color strength at the inlet and a second color strength at the outlet with the second color strength is lower than the first color strength.

8. A method of capturing dyestuff, the method comprising:
providing a filter according to claim 1; and
exposing effluent comprising dyestuff in a first amount to the filter to form effluent comprising dyestuff in a second amount;
wherein the second amount less than the first amount.

9. A method of sequestering dyestuff to form a cured dyestuff, the method comprising:
providing a filter comprising a cartridge or series of cartridges with substrate according to claim 1; exposing effluent comprising dyestuff in a first amount to the filter to form effluent comprising dyestuff in a second amount; and
the cartridge being unscrewed to release the substrate to air dry to form a cured dyestuff on the substrate.

10. The method of claim 9, wherein the cartridge structure itself is reusable and unscrews to release the bonded dyestuff waste to the substrate to air dry.

11. The method of claim 9 further comprising drying the combination of the dyestuff waste and the substrate to form the cured dyestuff on the substrate.

12. A circular method of recycling dyestuff to form a recycled pre dyed material, the method comprising:
providing a filter comprising a substrate according to claim 1;
exposing effluent comprising dyestuff in a first amount to the filter to form effluent comprising dyestuff in a second amount;
unscrewing the reusable cartridge or series of reusable cartridges which releases the substrate to form a cured dyestuff; and
manipulating the cured dyestuff bonded to the substrate to form a recycled dyed material.

13. The method of claim 12, wherein the filter contains a cartridge structure which unscrews and releases the ionically bonded waste dyestuff and substrate after use.

14. The method of claim 12 further comprising drying the combination of the waste dyestuff ionically bonded to the substrate to form the cured upcycled hydrolyzed dyestuff to the substrate.

15. The method of claim 12, wherein the step of manipulating the cured dyestuff to the substrate comprises mulching the cured waste dyestuff substrate to form recycled dyed fibers.

16. The method of claim 15, wherein the step of manipulating the cured waste dyestuff to the substrate further comprises spinning the recycled fibers to form recycled fibered material.

17. The method of claim 16, wherein the recycled fibered material comprises a rope, a yarn, or a combination thereof.

18. A filtering system for capturing dyestuff, comprising:
a discharge stream having a first discharge outlet and a second discharge outlet adapted to provide effluent comprising a dyestuff;
a first filter in fluid communication with the first discharge outlet and adapted to capture at least a portion of the dyestuff;
a second filter in fluid communication with the second discharge outlet and adapted to capture at least a portion of the dyestuff;
a sensor assembly in fluid communication with the first filter and the second filter and adapted to detect an amount of the dyestuff;
wherein the system is adapted to direct effluent to the second filter when the sensor detects a predetermined amount of dyestuff being released from the first filter.

19. The filtering system of claim 18, wherein the system is adapted to direct effluent to the first filter when the sensor assembly detects a predetermined amount of dyestuff being released from the second filter.

20. The filtering system of claim 19, wherein the sensor assembly comprises a colorimetric sensor adapted to detect color strength of effluent.

21. The filtering system of claim 18, wherein the discharge stream further comprises a third discharge outlet that is adapted to bypass the first filter and the second filter and is in fluid communication with the dyeing or washing system to let fluid without dyestuff bypass filter 1 and filter 2, or has an attachment to the dye vessel wherein the discharge stream which does not contain dyestuff is directed directly to the water treatment plant to be cleaned by existing methods and the discharge stream that contains dyestuff is directed to the dyestuff filtering system, a holding tank or a reverse osmosis filter which cleans the dyestuff effluent of any fibers or salt which was formed during the sometimes combined neutralization step and the dyestuff rinse off step.

22. The filtering system of claim 18, wherein at least one of the first filter and the second filter comprises:
a housing defining an inlet, an outlet spaced from the inlet and a cartridge or series of cartridges in a cavity in fluid communication with the inlet and the outlet, the inlet adapted to receive effluent comprising dyestuff, and the outlet adapted to release the effluent; and
a substrate disposed within the cartridge or series of cartridges comprising an active material, the active material having an affinity for the dyestuff;
wherein the dyestuff is present in the effluent at the inlet in a first amount and present in the effluent at the outlet in a second amount with the second amount less than the first amount.

23. The filtering system of claim 22, wherein the active material comprises a cationic material.

24. The filtering system of claim 23, wherein the cationic material comprises a quaternary ammonium compound, or a bi-quaternary ammonium compound and/or any cationic compound able to create a strong cationic charge on the cellulosic fiber or fabric being used as the substrate.

25. The filtering system of claim 24, wherein the quaternary ammonium compound is 3-chloro-2-hydroxypropyltrimethylammonium chloride (CHPTAC).

26. The filtering system of claim 18, wherein the substrate filled into the cartridge comprises cellulosic fibers, fabrics, or a combination thereof.

27. The filtering system of claim 26, wherein the cellulosic fiber comprises cotton, viscose, hemp, bamboo, wood pulp, etc.

28. The filtering system of claim 18, wherein the effluent has a first color strength at the inlet and a second color strength at the outlet with the second color strength is lower than the first color strength.

29. The filtering system of claim 18 wherein the filtering system is designed to be completely circular reusing all its parts, components, cartridges, substrate and upcycle normally discarded waste dyestuff.

30. The filter of claim 1 wherein the cartridge from the filter is reusable by having the ability to unscrew, separate, empty the used substrate with the dyestuff bonded to air dry to permanently bond, and then the cartridge can be easily repacked with fresh charged substrate to be used again following a circular model and not a linear model.

31. The filtering system of claim 18 wherein the filtering system further comprises a cartridge or series of cartridges which is reusable, contains a substrate with an ionic charge which can attract and filter anionic hydrolyzed dyestuff which is not a particle nor has the ability of forming a covalent bond.
